(19) United States
(12) Patent Application Publication
(10) Pub. No.: US 2001/0035426 A1
(43) Pub. Date: Nov. 1, 2001

(54) Self-serve wall-mounted mounthwash disperser (instarinse)

(76) Inventor: Dionisio Jose Chamorro, Miami Shores, FL (US)

Correspondence Address: Dionisio Chamorro, 1310 N.E. 101 St., Miami Shores, FL, 33138, US

(21) Appl. No.: 09/792,762

(22) Filed: Jun. 15, 2001

Related U.S. Application Data
(60) Provisional application No. 60/183,891, filed on Feb. 22, 2000.

(51) Int. Cl. G07F 11/00; A47F 1/00; G07F 11/16; A47F 1/04

(52) U.S. Cl. 221/96; 221/307; 222/105; 222/181.3; 222/192

(57) ABSTRACT

A Self-Serve wall mounted mouthwash fluid dispenser which provides a vertical rectangular container, having a diametrical separator to define two compartments. The left side of the container carries one-portion disposable cups that in turn would be used for collecting mouthwash. The light side of the container carries mouthwash fluid in a sealed hygienic plastic bag that in turn would be used for storing the fluid, later being released at the suppression of a lever. The cover defines an outer region designed for advertising to be filled by any of the mouthwash companies acquiring or leasing this patent or any of its main ideas and components. The special supplies like the one-portion disposable cups and the disposable hygienic bags, both in special packaging will be particular size and dimensions to be stipulated later by the inventor.

### BACKGROUND OF THE INVENTION

1. Field and purpose of the Invention

The present invention relates to a Mouthwash wall mounted hand dispenser, more specifically, a fluid dispensing machine operated by a single hand stroke to a lever which in return dispensing a predetermined amount of a mouthwash fluid into a one-portion disposable cup also found in a container attached to the main wall mounted hand dispenser. The purpose of the invention is to increase Mouthwash use in public bathrooms, airlines, trains, restaurant bathrooms and any other type office buildings, hence to increase oral hygienic.

2. The Relevant Technology

A reasonably common knowledge is that food after it has been digested creates decay of the teeth, bad odor, excess amounts of acid in the mouth, and possibly diseases, which are harmful to the teeth in the long run. As a result, people take mouthwash, toothbrushes and any type of chewing gums in small containers to work and other private and personal places to avoid all the causes stated. Accordingly, when people want to use any of the above choices, they must act in a secretive way to avoid possible embarrassment.

### OBJECTS AND BRIEF SUMMARY OF THE INVENTION

Accordingly, it is an object of the present invention to provide a higher oral hygienic to persons at leisure as well as in the workplace.

Another object of the present invention is to provide improved oral hygienic wherein mouthwash is dispensed through an contamination-free apparatus to be strategically placed in bathrooms (both public and private) in offices, airplanes, or restaurants. The purpose of this mouthwash dispenser is to prevent the use of the before-mentioned and other non-hygienic practices such as a stranger in a bathroom offering mouthwash in an open container in return for a tip.

### BRIEF DESCRIPTION OF THE DRAWINGS

In order that the manner in which the above recited and other advantages and objects of the invention are obtained, a more particular description of the invention briefly described above will be rendered by reference to specific embodiments thereof, which are illustrated, in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1 is a Front view of the Wall mounted Hand Dispenser;

FIG. 2 is a partial left side view of the Cup dispenser as shown in FIG. 1 with two windows for viewing and a cup sustainer for the unload of the one-portion cups;

FIG. 3 is a partial right side view of the Fluid dispenser as shown in FIG. 1 with pour lever;

FIG. 4 is an upper view of the Fluid dispenser apparatus as shown in FIG. 1 with a key lock to open the Wall mounted Hand Dispenser;

FIG. 5 is a bottom view of the Fluid dispenser apparatus as shown in FIG. 1 with a final dispensing valve in the middle and to the left the one-potion gravity operated cup dispenser as shown in FIG. 2;

FIG. 6 is a front view of the back metal frame consisting of metal hinges in the bottom and a metal hook in the center upper part of the frame.

FIG. 7 is a front view of the Fluid dispenser apparatus as shown in FIG. 1 from an inner view condition with an inner area for the mouthwash container, a dispensing valve apparatus, a pour lever and a gravity operated one-portion cup dispenser.

FIG. 8 is a front view of the Fluid dispenser apparatus as shown in FIG. 7 including a disposable bag for mouthwash with a plastic tip, and a pack of one-portion cups;

FIG. 9A is a front inner view of the dispenser valve in a closed position with fluid reaching the tilted palette as shown in the center bottom part of FIG. 7, and a horizontal tube reaching to the final pouring lever;

FIG. 10 is a front inner view of the dispenser valve in an open position with fluid passing through the tilted palette as shown in the center bottom part of FIG. 7, and a horizontal tube reaching to the final pouring lever;

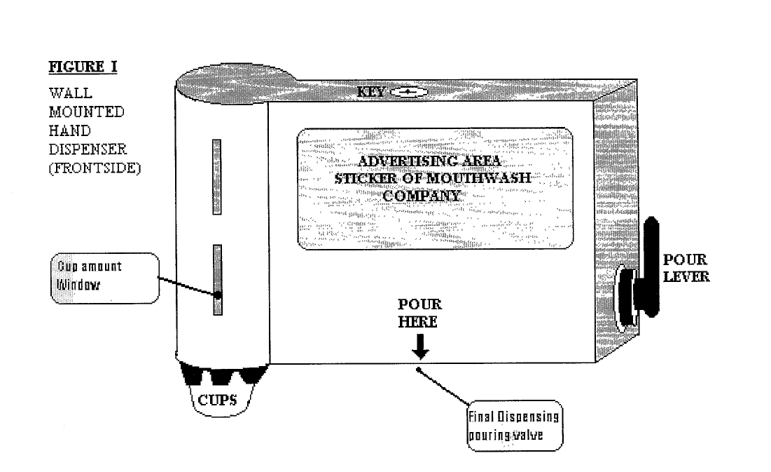

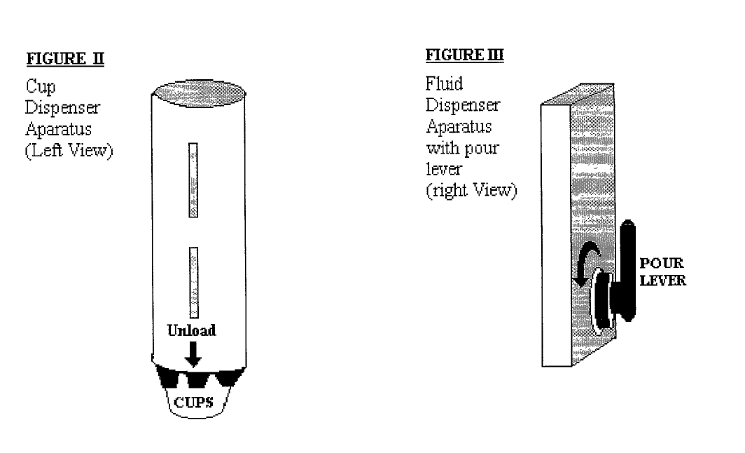

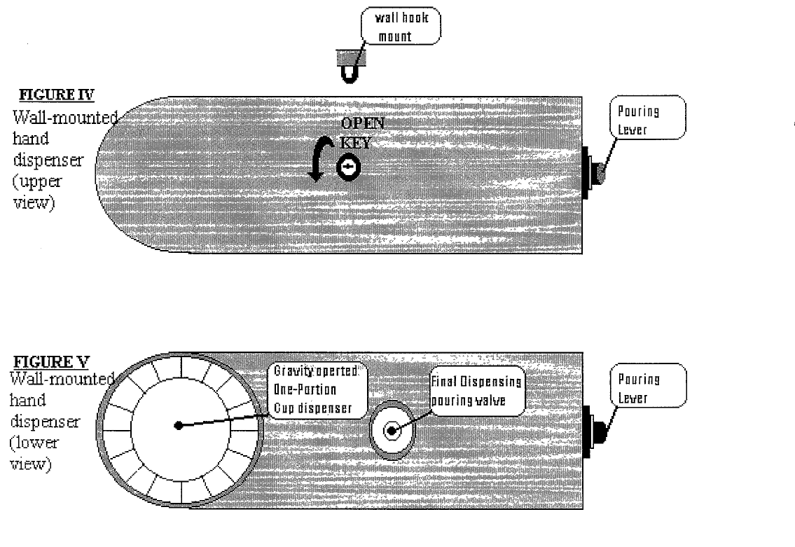

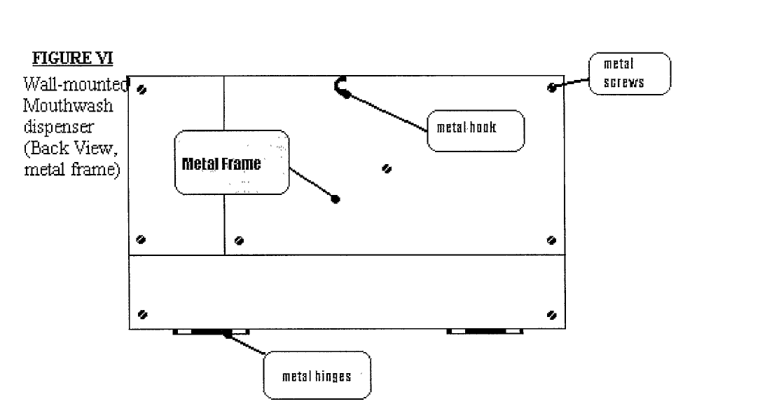

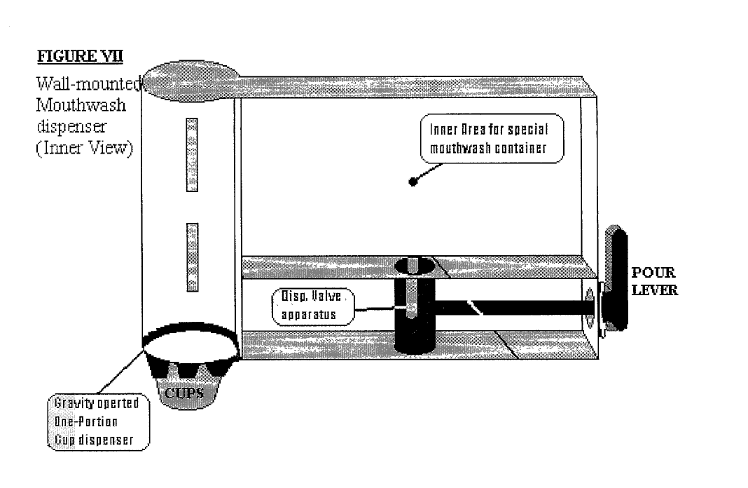

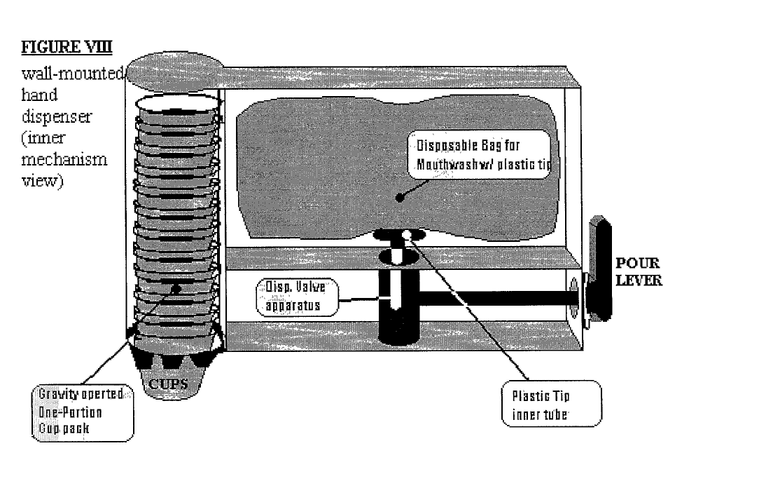

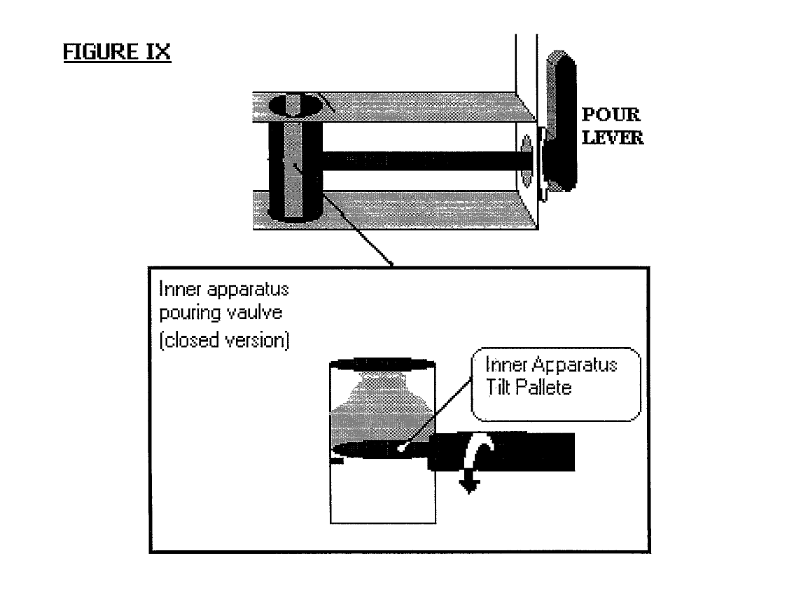

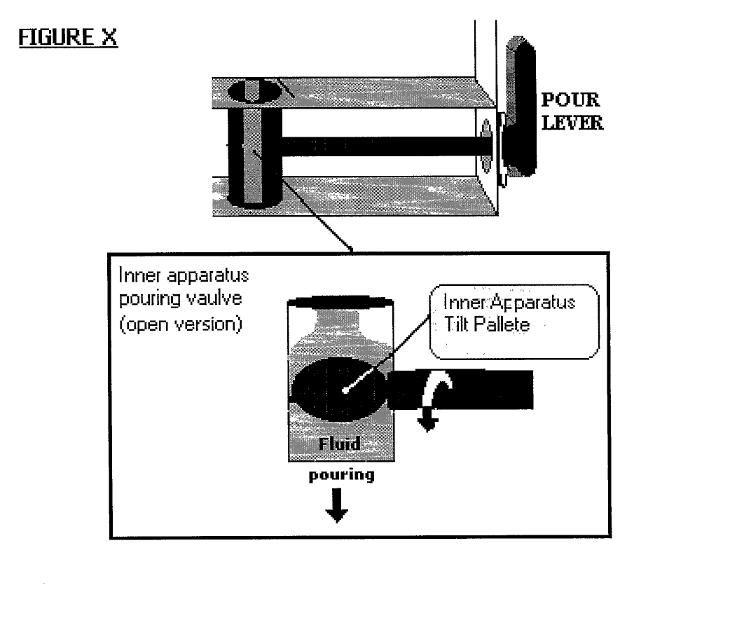

The foregoing description of my invention is detailed so that specific embodiment of it might be set forth as required, but it is to be understood that various modifications of detail, arrangement and multiplication of parts might be made without departing from its spirit, essence or scope.

Having thusly described my invention, I desire to protect by Letters Patent, and Type Patent through a provisional patent application.

I claim:

1. A container for selectively dispersing fluid, particularly mouthwash fluid, and cups, comprising of the following:
A body comprising of a self-serve wall mounted mouthwash fluid dispenser, having two compartments defined by a medial separator, the body having a rectangular shaped cover, a handle, and the surface defining the upper portion of each compartment being completely vertical in order to utilize gravity to release its contents independently.

2. The apparatus of claim 1 comprising of a cavity for holding a fluid (mouthwash), on the right side, to be filed by a sealed hygienic plastic bag that in turn would be used for storing the fluid, later to be released at the suppression of a lever;
The valving mechanism for the fluid dispenser comprises of a selective lever motion valve to allow a pre-established amount of fluid, to be disbursed from the plastic bag to the spout of the dispenser, and then to the final orifice;
The sealed hygienic plastic bag would be used for storing the fluid (mouthwash), with a particular connecting “male” valve connector, which in turn would be connected to the “female” valve connector in the main container, to direct the fluid to the actual valve, and to finally be released at the suppression of a lever.

3. The apparatus of claim 1 comprising of a container that carries one-portion disposable cups, on the left side, which in turn would be used for the collecting of the disbursed fluid (mouthwash);
The cups are exactly the size necessary for the prompt release of the cup holder, which in turn are specially tailored for the sole use the product released from the apparatus of claim 2.
